(19) United States
(12) Patent Application Publication
(10) Pub. No.: US 2019/0020082 A1
(43) Pub. Date: Jan. 17, 2019

(54) REVERSIBLE ELECTROCHEMICAL SYSTEM COMPRISING TWO PEM DEVICES IN OXIDATION AND REDUCTION ELECTRODES CONFIGURATION

(71) Applicant: Commissariat a l'energie atomique et aux energies alternatives, Paris (FR)

(72) Inventors: Baptiste VERDIN, Chambery (FR); Remi VINCENT, Grenoble (FR)

(73) Assignee: Commissariat a l'energie atomique et aux energies alternatives, Paris (FR)

(21) Appl. No.: 16/033,682

(22) Filed: Jul. 12, 2018

(30) Foreign Application Priority Data
Jul. 12, 2017 (FR) 17 56604

(51) Int. Cl. H01M 12/04; H01M 8/0656; H01M 8/1004; H01M 8/18; H01M 4/86

(52) U.S. Cl. CPC H01M 12/04; H01M 8/0656; H01M 8/1004; H01M 2004/8684; H01M 4/86; H01M 2004/8689; H01M 8/184

(57) ABSTRACT

The invention relates to a reversible electrochemical system intended to operate alternately in electrolysis cell mode and in fuel cell mode, comprising:
a primary device of which:
   the primary anode (13) is suitable for carrying out an oxidation of the water (OER) originating from a first anode port and an oxidation of the hydrogen (HOR) originating from a second anode port, and
   the primary cathode (15) is suitable for carrying out a reduction of protons (HER), and a reduction of oxygen (ORR) originating from a second cathode port;
a secondary device of which:
   the secondary anode (23) is suitable for carrying out an oxidation of hydrogen (HOR) originating from the primary anode and an oxidation of hydrogen (HOR) originating from the second anode port;
   the secondary cathode (25) is suitable for carrying out a reduction of protons (HER) and a reduction of oxygen (ORR) originating from the second cathode port.

### TECHNICAL FIELD

The field of the invention is that of reversible electrochemical systems with a proton exchange membrane. Such an electrochemical system is thus suitable for operating in “electrolysis cell” mode and in “fuel cell” mode.

### PRIOR ART

So-called reversible electrochemical systems with a proton exchange membrane are electrochemical systems suitable for operating both in “electrolysis cell” mode (EC mode) thus producing hydrogen and oxygen by electrolysis of water, and in “fuel cell” mode (FC mode) producing electrical energy and water by consumption of hydrogen and oxygen. Such an electrochemical system with a proton exchange membrane is customarily referred to as a regenerative fuel cell (RFC).

An RFC reversible electrochemical system may comprise two electrochemical devices that are separate from one another, of PEM (proton exchange membrane) type, namely a fuel cell and an electrolysis cell. As a variant it may comprise one and the same electrochemical device of PEM type suitable for operating alternately as an electrolysis cell and as a fuel cell. In the latter case, the electrochemical system is then referred to as a unitized regenerative fuel cell (URFC).

The article by Grigoriev et al. entitled “Design and characterization of bi-functional electrocatalytic layers for application in PEM unitized regenerative fuel cells”, Int. J. Hydrogen Energy 2010, 35, 5070-5076 describes an example of a unitized regenerative fuel cell, two variants of which are illustrated in FIGS. 1A-1B and 2A-2B. It comprises at least one electrochemical cell of PEM type, the membrane electrode assembly of which is formed of an proton-exchange electrolytic membrane 14, 14′ separating a first electrode 13, 13′ from a second electrode 15, 15′. It may have two different configurations, which differ from one another essentially by the management of the gases and therefore by the type of redox reactions taking place at the electrodes.

A first configuration, illustrated in FIGS. 1A and 1B, is referred to as oxygen and hydrogen electrodes configuration. Each electrode then treats the same gas, both in EC mode (FIG. 1A) and in FC mode (FIG. 1B). Thus, the first electrode 13′ is an anode that carries out the oxidation of water generating oxygen in EC mode, and a cathode that carries out the reduction of oxygen in FC mode. The second electrode 15′ is a cathode that carries out the reduction of protons in EC mode, and an anode that carries out the oxidation of hydrogen in FC mode. One drawback of this configuration is in particular that the oxygen electrode, here the first electrode 13′, may have decreased electrochemical performance due to the fact, on the one hand, of risks of degradation of the carbon-based support during the water oxidation reaction in EC mode and, on the other hand, of the presence of a less efficient catalyst for carrying out the oxygen reduction reaction in FC mode.

The second configuration, illustrated in FIGS. 2A and 2B, is referred to as reduction and oxidation electrodes configuration. Here, each electrode has the same type of redox reaction in EC mode (FIG. 2A) and in FC mode (FIG. 2B). Thus, the first electrode 13 is an anode that carries out the oxidation of water generating oxygen in EC mode, and the oxidation of hydrogen in FC mode. The second electrode 15 is a cathode that carries out the reduction of protons in EC mode and the reduction of oxygen in FC mode. The operation of this reversible electrochemical system in this configuration then necessitates reversing the fluids between EC and FC modes, and makes provision in particular for an intermediate step of purging liquid water and of drying the electrodes.

### SUMMARY OF THE INVENTION

The objective of the invention is to at least partly overcome the drawbacks of the prior art, and more particularly to provide a reversible electrochemical system that makes it possible to obtain improved electrochemical performance.

For this reason, the subject of the invention is a reversible electrochemical system having first anode and cathode ports and opposite second anode and cathode ports, which is intended to operate alternately: in electrolysis cell mode in which it is suitable for receiving water to be electrolysed at the first anode port and for supplying oxygen to the second anode port and hydrogen to the second cathode port, and in fuel cell mode, in which it is suitable for receiving hydrogen at the second anode port and oxygen at the second cathode port and for supplying water to the first cathode port.

It comprises a primary electrochemical device comprising a membrane electrode assembly, comprising a primary anode and a primary cathode separated by a primary proton-exchange membrane: the primary anode, connected to the first anode port and the second anode port, being suitable for carrying out an oxidation of water originating from the first anode port and an oxidation of hydrogen originating from the second anode port; and the primary cathode, connected to the first cathode port and the second cathode port, being suitable for carrying out a reduction of protons, and a reduction of oxygen originating from the second cathode port.

According to invention, the reversible electrochemical system comprises a secondary electrochemical device comprising a membrane electrode assembly, comprising a secondary anode and a secondary cathode separated by a secondary proton-exchange membrane: the secondary anode being connected to the primary anode and to the second anode port, and being suitable for carrying out an oxidation of hydrogen originating from the primary anode and an oxidation of hydrogen originating from the second anode port; and the secondary cathode being connected to the primary cathode and to the second cathode port, and being suitable for carrying out a reduction of protons and a reduction of oxygen originating from the second cathode port.

Certain preferred, but nonlimiting, aspects of this reversible electrochemical system are the following.

The primary electrolytic membrane may have a mean thickness less than or equal to 100 μm.

The primary electrolytic membrane may have a mean thickness less than that of the secondary electrolytic membrane.

The secondary electrolytic membrane may have a mean thickness greater than 100 μm.

The reversible electrochemical system may comprise a so-called primary electrical source suitable for applying, in electrolysis cell mode, a first electrical signal between the primary anode and primary cathode, and a so-called secondary electrical source suitable for applying, in electrolysis cell mode, a second electrical signal between the secondary anode and secondary cathode, the second electrical signal being of the same sign as the first electrical signal and of a lower intensity.

The reversible electrochemical system may comprise at least one anode circuit for fluid circulation connecting the first anode port to the second anode port passing through the primary and secondary anodes, and at least one cathode circuit for fluid circulation connecting the first cathode port to the second cathode port passing through the primary and secondary cathodes.

The invention also relates to a process for operating the reversible electrochemical system according to any one of the preceding features, comprising an alternation between:
at least one step in electrolysis cell mode in which water is introduced at the first anode port in superstoichiometry with respect to the primary device;
at least one step in fuel cell mode in which hydrogen and oxygen are introduced respectively at the second anode and cathode ports in superstoichiometry at least with respect to the secondary device.

The process may comprise, between a step in electrolysis cell mode and a step in fuel cell mode, an intermediate step for purging liquid water present in the reversible electrochemical system by injection of nitrogen.

The process may comprise a step of obtaining nitrogen by injecting air at the second cathode port, the reversible electrochemical system operating in closed-loop fuel cell mode.

### BRIEF DESCRIPTION OF THE DRAWINGS

Other aspects, objectives, advantages and features of the invention will become more apparent on reading the following detailed description of preferred embodiments thereof, given by way of nonlimiting example, and with reference to the appended drawings in which:

FIGS. 1A and 1B, already described, schematically illustrate a unitized regenerative fuel cell in so-called oxygen and hydrogen electrodes configuration, according to an example from the prior art, in electrolysis cell mode (FIG. 1A) and in fuel cell mode (FIG. 1B);

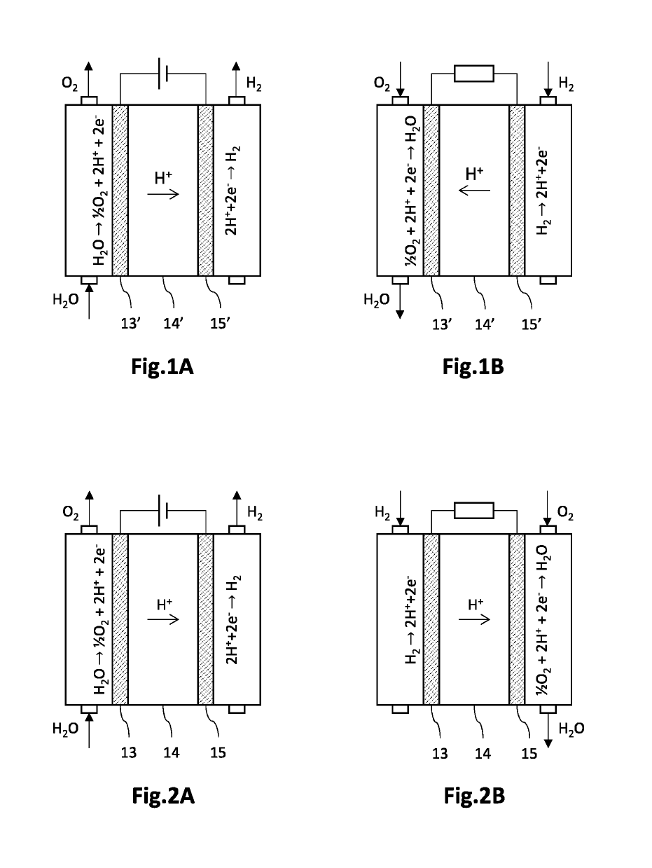

FIGS. 2A and 2B, already described, schematically illustrate a unitized regenerative fuel cell in so-called oxidation and reduction electrodes configuration, according to another example from the prior art, in electrolysis cell mode (FIG. 2A) and in fuel cell mode (FIG. 2B);

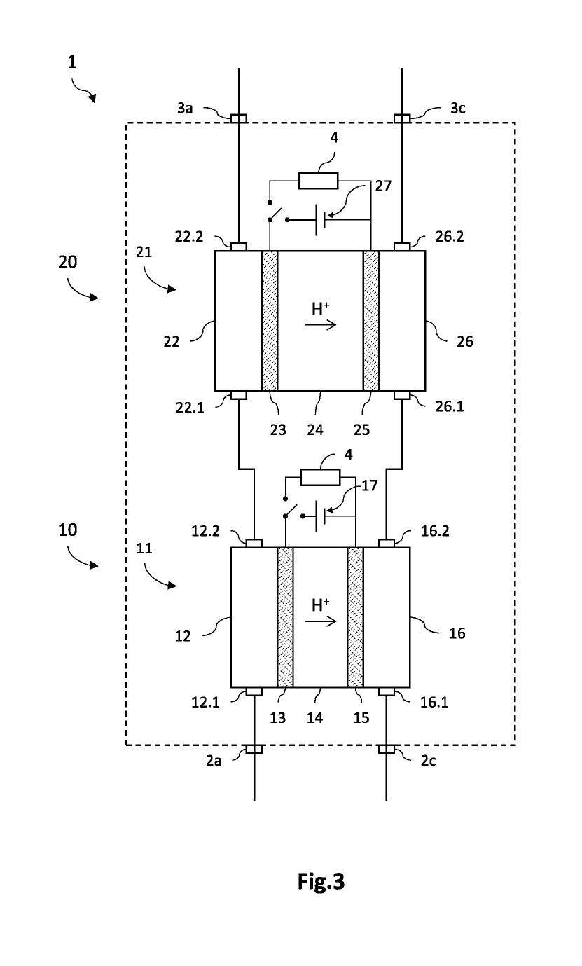

FIG. 3 is a schematic view of a reversible electrochemical system according to one embodiment;

FIGS. 4A and 4B are schematic views of the electrochemical system illustrated in FIG. 3 operating in electrolysis cell mode (FIG. 4A) and in fuel cell mode (FIG. 4B).

### DETAILED DESCRIPTION OF PARTICULAR EMBODIMENTS

In the figures and in the remainder of the description, the same references represent identical or similar elements. The various elements are not represented to scale in order to make the figures clearer. Moreover, the various embodiments and variants are not mutually exclusive and may be combined together. Unless otherwise indicated, the terms “substantially”, “approximately”, “of” the order of mean to within 10% and preferably to within 5%. The expression of the type “comprising a” should be understood as “comprising at least one”, unless otherwise indicated.

The invention relates to a reversible electrochemical system suitable for operating alternately in electrolysis cell mode (EC mode) and in fuel cell mode (FC mode). It comprises first fluid inlet/outlet ports referred to as first anode and cathode ports, respectively connected to second fluid inlet/outlet ports referred to as second anode and cathode ports. In EC mode, the reversible system is suitable for carrying out the electrolysis of the water received at the first anode port in order to supply oxygen to the second anode port and hydrogen to the second cathode port. In FC mode, it is suitable for receiving hydrogen at the second anode port and oxygen at the second cathode port in order to supply electricity and water to the first cathode port.

For this reason, the reversible system comprises at least two electrochemical devices, referred to as primary and secondary devices, fluidically positioned in series with one another between the first ports and the second ports. The primary device is a unitized regenerative fuel cell (URFC) in reduction and oxidation electrodes configuration. The secondary device is suitable, in EC mode, for separating the hydrogen contained in the oxygen resulting from the anode of the primary device, and, in FC mode, for operating as a fuel cell. It also has an oxidation and reduction electrodes configuration.

Each of the primary and secondary devices comprises one or more electrochemical cells each comprising a membrane electrode assembly (MEA) the electrolytic membrane of which is of proton exchange type. Each electrolytic membrane is inserted between an oxidation electrode, that is to say an anode, and a reduction electrode, that is to say cathode. The MEA(s) of the primary device is/are positioned in series with that or those of the secondary device, between the first ports and the second ports. Thus, the first anode port and the second anode port are fluidically connected to one another by the primary anode and the secondary anode, so that a fluid flowing between the first anode port and the second anode port comes into contact with the primary anode and with the secondary anode. In an identical manner, the first cathode port and the second cathode port are fluidically connected to one another by the primary cathode and the secondary cathode, so that a fluid flowing between the first cathode port and the second cathode port comes into contact with the primary cathode and with the secondary cathode.

The primary and secondary devices thus have a configuration referred to as oxidation and reduction electrodes configuration and are not in a hydrogen and oxygen electrodes configuration. In other words, each electrode of the MEAs is the site of a redox reaction of the same type in EC mode and in FC mode. More specifically, the oxidation electrodes, namely the anodes, are the site of a hydrogen oxidation reaction (HOR) or of a water oxidation reaction (referred to as OER, for Oxygen Evolution Reaction). The reduction electrodes, namely the cathodes, are the site of a proton reduction reaction (referred to as HER, for Hydrogen Evolution Reaction) or of an oxygen reduction reaction (ORR).

Thus, such a reversible electrochemical system makes it possible to obtain improved electrochemical performance compared to the URFC examples from the prior art mentioned above, in so far as the presence of the secondary device allows the thinning of the primary electrolytic membrane. Specifically, the reduction in the mean thickness of the primary membrane makes it possible to reduce the proton ohmic resistance and therefore to improve the electrochemical performance of the primary device, in particular in EC mode, but also in FC mode. In EC mode, the electric consumption of the secondary device remains low, so that the reversible system thus has improved electrochemical performance.

The thinning of the primary membrane may result, in EC mode, in hydrogen generated at the primary cathode diffusing to the primary anode and mixing with the oxygen generated. The secondary device then operates as a separator ensuring the selective oxidation of the hydrogen present, which reduces the risks of ignition. Thus, the electrochemical performance is improved, while maintaining safety with respect to risks of ignition.

The electrolytic membrane of the primary device may thus be thinned, so that it has a mean thickness less than or equal to 100 μm, preferably less than or equal to 80 μm, or even less than or equal to 70 μm, and preferably equal to 50 μm approximately. The mean thickness is here the mean of the local thickness of the membrane for a given clamping force, for example zero.

The mean thickness of the primary membrane may then be less than that of the electrolytic membrane of the secondary device, the performance of which is less sensitive. The secondary electrolytic membrane may thus have a mean thickness greater than 100 μm, for example equal to 150 μm approximately or to 180 μm approximately. The primary and secondary electrolytic membranes advantageously have the same physical properties but may then differ from one another essentially by the value of their mean thickness, at identical clamping force.

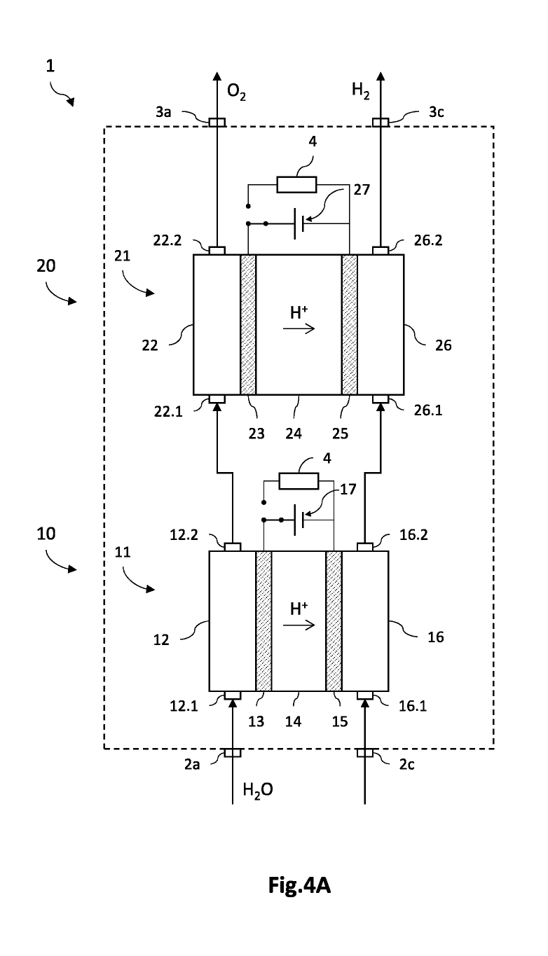

FIG. 3 schematically illustrates a reversible electrochemical system 1 according to one embodiment. As mentioned previously, the reversible electrochemical system 1 is suitable for operating alternatively in electrolysis cell mode (EC mode) and in fuel cell mode (FC mode). It is thus suitable, in EC mode, for receiving water at the first anode port 2a in order to supply oxygen to the second anode port 3a as well as excess water and hydrogen to the second cathode port 3c as well as water electro-osmosed across the membrane, and, in FC mode, for receiving hydrogen at the second anode port 3a and oxygen at the second cathode port 3c in order to supply water to the first cathode port 2c as well as excess oxygen and electrical energy. The reversible system 1 comprises a primary electrochemical device 10 forming a URFC cell in oxidation and reduction electrodes configuration, and a secondary electrochemical device 20 forming a separator for the hydrogen present in the oxygen generated by the primary device 10 in EC mode, and a fuel cell in FC mode. It is also in oxidation and reduction electrodes configuration.

The primary electrochemical device 10 is a unitized regenerative fuel cell (URFC). It is thus suitable, in EC mode, for operating as an electrolysis cell using water received at the first anode port 2a, and, in FC mode, for operating as a fuel cell using hydrogen and oxygen transmitted by the secondary device 20 respectively from the second anode 3a and cathode 3c ports.

For this reason it comprises at least one electrochemical cell 11, referred to as the primary cell, the membrane electrode assembly of which is formed of a primary anode 13 and a primary cathode 15 separated from one another by an electrolytic proton-exchange membrane 14. It further comprises anode 12 and cathode 16 fluid distribution circuits, which are suitable for circulating a fluid respectively along and in contact with the primary anode 13 and with the primary cathode 15. Furthermore, the MEA may be electrically connected to an electrical source 17 in EC mode, for example a current source, and to an electric charge 4 in FC mode.

The primary anode 13 comprises an active layer suitable for carrying out a water oxidation reaction (OER) in EC mode, and also a hydrogen oxidation reaction (HOR) in FC mode. It thus comprises at least one catalyst, and preferably several different catalysts promoting these two oxidation reactions, for example iridium oxide promoting the water oxidation reaction, and platinum promoting the hydrogen oxidation reaction. By way of illustration, the active layer may comprise, on a support that here is not based on carbon, 2 mg/cm² of iridium oxide and between 0.2 and 0.5 mg/cm² of platinum black. The water oxidation reaction (OER) is written:

H₂O→2H⁺+2e⁻+½O₂,

And the hydrogen oxidation reaction (HOR) is written:

H₂→2H⁺+2e⁻

The primary cathode 15 comprises an active layer suitable for carrying out a proton reduction reaction (HER) in EC mode, and also an oxygen reduction reaction (ORR) in FC mode. It thus comprises at least one catalyst that promotes these two reduction reactions, for example platinum promoting the reduction of the protons as well as that of the oxygen. By way of illustration, the active layer may comprise platinum on a carbon-based support with a loading of between 0.5 and 1 mg/cm² approximately. The proton reduction reaction (HER) is written:

2H⁺+2e⁻→H₂,

And the oxygen reduction reaction (ORR) is written:

2H⁺+2e⁻+½O₂→H₂O

The primary electrolytic membrane 14 is of proton exchange type. It enables the diffusion of the protons from the primary anode 13 to the primary cathode 15, it being possible for the protons to be within the primary membrane 14 in the form of H₃O⁺ ions. It has a non-zero hydrogen permeation coefficient, which thus allows the diffusion of hydrogen across the primary membrane 14, from the primary cathode 15 to the primary anode 13. The primary membrane 14 may be made from materials customarily chosen by a person skilled in the art, such as those marketed under the reference Nafion N212 or Nafion NE1035 which have a hydrogen permeation coefficient of the order of 1.25×104 cm³/s/cm² at 80° C. and at atmospheric pressure, or even those marketed under the reference Nafion N1135. Starting from these reference membranes, the primary membrane 14 is advantageously thinned, so that it has a mean thickness, at zero clamping force, less than or equal to 100 μm, preferably less than or equal to 80 μm, or even less than or equal to 70 μm, for example equal to 50 μm approximately such as the reference N212. Such a mean membrane thickness thus makes it possible to reduce its ohmic resistance, which improves the electrochemical performance of the primary device 10 in EC mode, but also in FC mode. This may then result, in EC mode, in a greater diffusion of the hydrogen generated at the primary cathode 15 by permeation across the primary membrane 14 to the primary anode 13, the hydrogen then mixing in the oxygen generated. This hydrogen will then be oxidized by the secondary device 20.

An electrical source 17, for example a current source 17 is intended to be electrically connected to the electrodes 13, 15 of the primary electrochemical cell 11 during EC mode. It then generates a DC electric potential difference V1 between the primary anode 13 and the primary cathode 15. The voltage V1 is positive, in the sense that the electric potential set at the primary anode 13 is greater than that set at the primary cathode 15. It may be between 1.3 V and 3 V, for example equal to 1.8 V approximately, for a current density between 50 mA/cm² and 4 A/cm² approximately. The voltage V1 resulting from the application of the current I1 during EC mode thus makes it possible to ensure the oxidation of water (OER) at the primary anode 13, the circulation of the electrons in the electric circuit to the primary cathode 15, and the reduction of the protons (HOR) at the primary cathode 15. The electrical source 17 may alternatively be a voltage source.

An electric charge 4 is intended to be electrically connected to the primary electrochemical cell 11 during FC mode. It is suitable for receiving the electric current generated at the primary anode 13 by the hydrogen oxidation reaction (HOR). Thus, an electric potential difference is applied to the terminals of the electric charge 4, where the potential applied by the primary cathode 15 is greater than that applied by the primary anode 13. The voltage applied by the primary electrochemical cell 11 to the electric charge 4 may be of the order of 0.7 V. The sign of the voltage is opposite to that of the voltage V1, but the direction of the electric current is not reversed.

The primary electrochemical cell 11 comprises anode 12 and cathode 16 fluid distribution circuits, which ensure the flow of fluid along and in contact with the primary anode 13 and primary cathode 15 respectively. Thus, the anode distribution circuit 12 ensures the fluid flow between a first anode manifold 12.1 and a second anode manifold 12.2 opposite the first. The first anode manifold 12.1 is connected to the first anode port 2a, and the second anode manifold is connected to an anode fluid distribution circuit 22 of the secondary device 20. Similarly, the cathode distribution circuit 16 ensures the fluid flow between a first cathode manifold 16.1 and a second cathode manifold 16.2 opposite the first. The first cathode manifold 16.1 is connected to the first cathode port 2C, and the second cathode manifold 16.2 is connected to a cathode fluid distribution circuit 26 of the secondary device 20.

The secondary electrochemical device 20 is suitable, in EC mode, for forming a device for separating the hydrogen present in the oxygen originating from the anode 13 of the primary device 10, and, in FC mode, for forming a fuel cell using the hydrogen and oxygen received respectively at the second anode 3a and cathode 3c ports. Like the primary device 10, it has an oxidation and reduction electrodes configuration.

For this reason it comprises at least one so-called secondary electrochemical cell 21, the membrane electrode assembly of which is formed of a secondary anode 23 and of a secondary cathode 25 separated from one another by an electrolytic proton-exchange membrane 24. It further comprises anode 22 cathode 26 fluid distribution circuits, suitable for circulating a fluid respectively along and in contact with the secondary anode 23 and with the secondary cathode 25. Furthermore, the MEA may be electrically connected to an electrical source 27 in EC mode, for example a current source, and to an electric charge 4 in FC mode. The electric charge may be that one intended to be connected to the primary device 10 or may be different from the latter.

The secondary anode 23 comprises an active layer suitable for carrying out a hydrogen oxidation reaction (HOR), whether in EC mode or in FC mode. It thus comprises at least one catalyst promoting this oxidation reaction, preferably platinum particles supported by carbon, or even palladium.

The secondary cathode 25 comprises an active layer suitable for carrying out a proton reduction reaction (HER) in EC mode, and also an oxygen reduction reaction (ORR) in FC mode. It thus comprises one or more catalysts promoting these reduction reactions, for example platinum promoting the reduction of the protons as well as the reduction of the oxygen. By way of illustration, the active layer may comprise platinum particles supported by carbon with a loading of between 0.5 and 1 mg/cm² approximately, or even palladium.

The secondary electrolytic membrane 24 is of proton exchange type. It enables the diffusion of the protons from the secondary anode 23 to the secondary cathode 25, it being possible for the protons to be in the form of H₃O⁺ ions. It may be identical or different, in composition, relative to the primary membrane 14. Preferably, it has however a mean thickness greater than that of the primary membrane 14, thus limiting the amount of hydrogen that has diffused by permeation from the secondary cathode 25 to the secondary anode 23. It may be made from materials customarily chosen by a person skilled in the art, such as those marketed under the reference Nafion 115 or Nafion 117 which have a hydrogen permeation coefficient of the order of 1.25×104 cm³/s/cm² at 80° C. and at atmospheric pressure. The secondary membrane 24 may then have a mean thickness, at zero clamping force, of greater than 100 μm, for example equal to 150 μm or to 180 μm approximately.

The electrical source 27, for example here a current source, is intended to be electrically connected to the electrodes 23, 25 of the secondary electrochemical cell 21 during EC mode. It is suitable for generating a DC electric potential difference V2 between the secondary anode 23 and the secondary cathode 25. The voltage generated V2 is positive, like the voltage V1, in the sense that the electric potential at the secondary anode 23 is greater than that of the secondary cathode 25. It has an intensity lower than that of the voltage V1, for example 10 times lower, and may be equal to 0.2 V approximately. The voltage V2 thus enables the oxidation of the hydrogen (HOR) at the secondary anode 23, the circulation of the electrons in the electric circuit, and the reduction of the protons (HER) at the secondary cathode 25. The electrical source 27 may alternatively be a voltage source.

An electric charge 4, which may be the electric charge then connected to the primary cell, or a different electric charge, is intended to be electrically connected to the secondary electrochemical cell during FC mode. It is suitable for receiving the electric current generated at the secondary anode 23 by the hydrogen oxidation reaction (HOR). Thus, an electric potential difference is applied to the terminals of the electric charge, where the potential applied by the secondary cathode 25 is greater than that applied by the secondary anode 23. The voltage applied by the secondary electrochemical cell 21 may be of the order of 0.7 V. The sign of this voltage is opposite to that of the voltages V1 and V2.

The secondary cell 21 comprises anode 22 and cathode 26 fluid distribution circuits, which ensure the flow of fluid along and in contact with the secondary anode 23 and secondary cathode 25, respectively. Thus, the anode distribution circuit 22 ensures fluid flow between a first anode manifold 22.1 and a second anode manifold 22.2 opposite the first. The first anode manifold 22.1 is connected to the anode distribution circuit 12 of the primary device 10, and the second anode manifold 22.2 is connected to the second anode port 3a. Similarly, the cathode distribution circuit 26 ensures fluid flow between a first cathode manifold 26.1 and a second cathode manifold 26.2 opposite the first. The first cathode manifold 26.1 is connected to the cathode distribution circuit 16 of the primary device 10, and the second cathode manifold 26.2 is connected to the second cathode port 3c.

Thus, the primary 10 and secondary 20 devices of the reversible electrochemical system 1 are in so-called oxidation and reduction electrodes configuration. Specifically, in EC mode and in FC mode, the primary 13 and secondary 23 anodes are the site of oxidation reactions and the primary 15 and secondary 25 cathodes are the site of reduction reactions. This means that, in operation, the gases produced at the second ports 3a, 3c are reversed between the EC mode and the FC mode. More specifically, the second anode port 3a mainly supplies oxygen in EC mode but receives hydrogen in FC mode, and the second cathode port 3c mainly supplies hydrogen in EC mode but receives oxygen in FC mode.

The reversible electrochemical system 1 may be connected, by the second ports 3a, 3c, to a device (not represented) for storing the hydrogen and oxygen generated during the operation in EC mode. It may also be connected to an intermediate fluid management device (not represented), suitable for connecting the second anode port 3a to the oxygen storage vessel during EC mode or to the hydrogen storage vessel during FC mode, and for connecting the second cathode port 3c to the hydrogen storage vessel during EC mode or to the oxygen storage vessel during FC mode. A purge device may also be provided in order to dry the primary and secondary MEAs between the EC and FC phases, for example by circulating air or nitrogen. The nitrogen may have been obtained by the reversible system 1 operating in closed-loop FC mode, and more specifically in closed cathode loop FC mode. Thus, the air received at the first cathode port 2C is reinjected at the second cathode port 3c, and the reversible system 1 gradually consumes the oxygen until the gas essentially comprises only nitrogen.

Furthermore, according to one embodiment, the primary device m comprises a thinned primary membrane 14, that is to say that the mean thickness thereof is less than or equal to 100 μm, and preferably less than that of the electrolytic membrane 24 of the secondary device 20. Thus, the reduction in the mean thickness of the primary membrane 14 results in an increase in the performance of the reversible system 1, in so far as the proton ohmic resistance is reduced. Specifically, the reduction in the mean thickness of the primary membrane 14 makes it possible to reduce the potential difference V1 applied at the primary anode 13 and primary cathode 15 in EC mode, for the same electric current density. Thus, the electric power needed for the electrolysis of water is reduced, which makes it possible to obtain a better overall efficiency of the reversible system 1 in EC mode, the overall efficiency being defined here as the ratio between the gross calorific value of the gas produced and the electric power consumed. As a variant, for a reduced mean thickness of the primary membrane 14 and at unchanged voltage V1, the electric current density may be considerably increased, and thus the production of hydrogen may consequently be increased.

However, this reduction in the mean thickness of the primary membrane 14 may result, in EC mode, in hydrogen generated at the primary cathode 15 diffusing to the primary anode 13 by permeation and thus mixing with the oxygen generated. The secondary device 20 then carries out the separation of the hydrogen contained in the oxygen, thus making it possible to limit the volume fraction of hydrogen in the oxygen, and therefore to limit the risks of ignition in the anode circuits.

The secondary device 20 may be sized, especially in terms of active surface of the secondary membrane 24, so that, in EC mode, the proportion of hydrogen in the oxygen at the second anode port 3a is substantially less than or equal to a predefined value. The active surface is defined as being the surface of the electrolytic membrane located between and in contact with an anode and a cathode.

Therefore, a process for producing the reversible electrochemical system 1 may comprise a step of calculating the active surface of the secondary device 20 so that the proportion of hydrogen in the oxygen at the outlet of the secondary anode 23 has a so-called outlet value less than or equal to a predefined value, taking into account a so-called inlet value of the volume proportion of hydrogen at the inlet 22.1 of the secondary anode 23 and the value of the voltage V2 applied during EC mode.

Specifically, the thickness of the primary electrolytic membrane 14 of the primary device 10 may be sized as a function of the value accepted by the user of the volume proportion of hydrogen in oxygen at the primary anode outlet 12.2. More specifically, the proportion of hydrogen may be written as the ratio d_{H2}/d_{O2} between a molar flow rate d_{H2} of hydrogen that has migrated by permeation across the primary membrane 14 and a molar flow rate d_{O2} of oxygen produced at the primary anode 13. This ratio d_{H2}/d_{O2} is inversely proportional to the value of the mean thickness of the primary membrane 14. Specifically, the molar flow rate d_{H2} of hydrogen received at the primary anode 13 is proportional to the ratio of the active surface Sₘ of the primary membrane 14 to the mean thickness eₘ of the primary membrane 14, in other words: d_{H2}∝Sₘ/eₘ. Furthermore, the molar flow rate d_{O2} produced at the primary anode 13 by oxidation of water during EC mode is proportional to the electric current I of the primary device 10: d_{O2}∝I. Thus, the ratio d_{H2}/d_{O2} is proportional to Sₘ/(eₘ×I). Therefore, it is possible to determine the thickness of the primary membrane 14 as a function of a given tolerance for permeation of hydrogen across the primary membrane 14, and therefore as a function of an accepted value of the volume proportion of hydrogen in oxygen at the primary anode outlet 12.2.

As mentioned above, the sizing of the secondary device 20, and in particular of the active surface of the secondary electrolytic membrane 24, makes it possible to reduce, during EC mode, the volume proportion V_{H2} of hydrogen in oxygen so that it changes from a high value V_{H2,e} at the secondary anode inlet 22.1 to a low value V_{H2,s} at the secondary anode outlet 22.2. Specifically, the difference between the high inlet value V_{H2,e} and the low outlet value V_{H2,s} of the proportion of hydrogen V_{H2} in the secondary device 20 corresponds to the molar flow rate of hydrogen d_{H2,20} that has been oxidized at the secondary anode 23, which is proportional to the electric current I₂₀ of the secondary device 20: d_{H2,20} ∝I₂₀. Thus, for a given voltage V2 and an electric current I₂₀ that make it possible to obtain the desired molar flow rate of hydrogen d_{H2,20}, the polarization curve V2=f(i₂₀) of the secondary device 20 in EC mode makes it possible to deduce the value of the current density i₂₀ required, and therefore the minimum value of the active surface Sm₂₄ of the secondary membrane 24. The low outlet value V_{H2,s} may therefore be less than or equal to a predetermined threshold value.

Furthermore, in FC mode, the secondary device 20 operates as an additional fuel cell, making it possible to meet a need for electric power on the part of the electric charge.

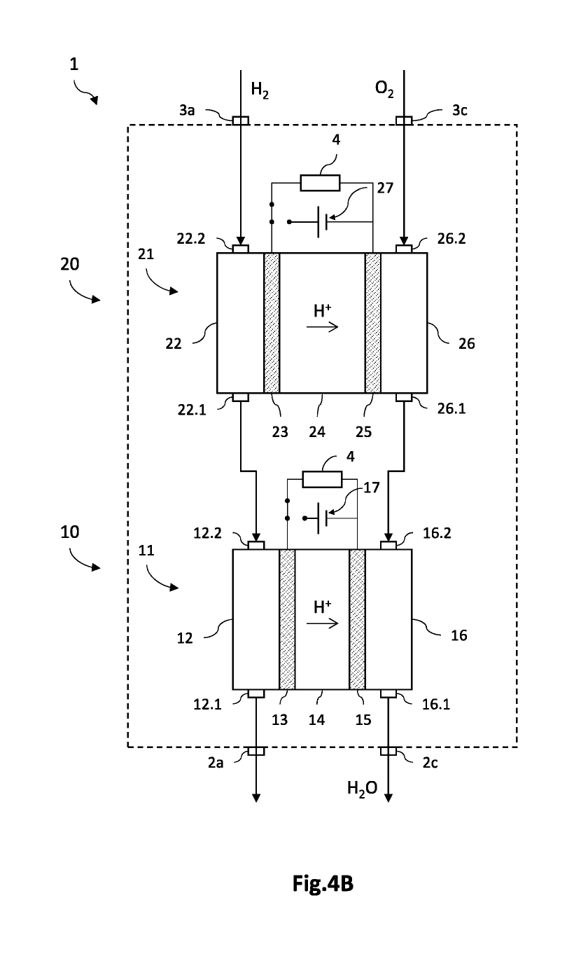

The operation of the reversible electrochemical system 1 according to the embodiment illustrated in FIG. 3 is now illustrated with reference to FIGS. 4A and 4B.

FIG. 4A illustrates a phase in which the electrochemical system operates in EC mode, that is to say that it carries out the electrolysis of water introduced at the first anode port 2a, thus generating oxygen and hydrogen at the second ports 3a, 3c.

Water is thus supplied to the first anode port 2a of the reversible system 1, which is transmitted to the anode distribution circuit 12 of the primary device 10, and therefore to the primary anode 13. The anode pressure may be equal to 1 bar approximately. The liquid water injected may be in superstoichiometry with respect to the primary device 10, for example having a ratio 10, so that the amount of water injected at the first anode port 2a is greater than the amount of water consumed at the primary anode 13, and preferably sufficient to discharge the heat produced. Preferably, water is also introduced at the first cathode port 2c, so as to ensure correct wetting of the primary membrane 14. The cathode pressure at the first cathode port 2C may be of the order of several tens of bar, for example is equal to 30 bar approximately.

Due to the application by the electrical source of the voltage V1 at the primary anode 13 and primary cathode 15, and due to the presence of a suitable catalyst at the primary anode 13 (here iridium oxide), the primary device 10 carries out the oxidation of water (OER) at the primary anode 13 and the reduction of protons (HER) at the primary cathode 15. The water is thus oxidized, which generates oxygen, electrons and protons, the latter diffusing across the primary membrane 14 to the primary cathode 15. The primary cathode 15 carries out the reduction of the protons received, by the voltage V1 applied and the presence of a suitable cathode catalyst (here platinum particles), thus generating hydrogen.

In this example, the primary membrane 14 is advantageously thinned, and then has a mean thickness less than or equal to 100 μm. Hydrogen formed at the primary cathode 15 can then diffuse by permeation across the primary membrane 14 and joins the anode circuit 12. Thus, a mixture of oxygen and hydrogen is found at the outlet 12.2 of the primary anode 13. The volume proportion of hydrogen in oxygen may be greater than 4%, for example may be equal to 10% or even to 20% approximately, without there being a safety risk when liquid water is also present due to the superstoichiometry. At the outlet 16.2 of the primary cathode 15, is hydrogen formed at the cathode and optionally liquid water. The fluids resulting from the anode 13 from the cathode 15 of the primary device 10 are transmitted to the anode 23 and the cathode 25, respectively, of the secondary device 20.

Due to the application of a voltage V2 between the secondary anode 23 and the secondary cathode 25, and due to the presence of a suitable anode catalyst (here platinum particles), the secondary device 20 carries out, at the anode 23, the oxidation of the hydrogen present (HOR), without the oxygen and liquid water being oxidized by the catalyst used due in particular to the low voltage value, and the reduction of protons (HER) at the cathode 25. The protons diffuse across the secondary membrane 24 of the anode 23 to the cathode 25, where they are reduced, thus generating hydrogen. Thus, the volume proportion of hydrogen in oxygen at the outlet 22.2 of the secondary anode 23 is then lower than the value at the outlet 12.2 of the primary anode 13, and is less than or equal to a predefined value, for example 4%, or even 2% or less. Preferably, the active surface of the secondary device 20 is adapted so that substantially all the hydrogen initially present is oxidized.

Thus, the reversible electrochemical system 1 supplies, in EC mode, essentially oxygen at the second anode port 3a, and where appropriate liquid water with a reduced volume proportion of hydrogen in so far as the hydrogen that has diffused has been at least partly oxidized at the secondary anode 23. The reversible system 1 supplies, at the second cathode port 3c, hydrogen and where appropriate liquid water. Phase separators (not represented) may be present in order to collect the liquid water and allow the gases to flow. The hydrogen and oxygen generated by electrolysis of water may, one and/or the other, be stored by the storage device (not represented).

Thus, the reversible electrochemical system 1 may carry out the electrolysis of water with improved electrochemical performance due to the thin thickness of the primary membrane 14. The volume proportion of hydrogen in oxygen, due to the permeation of hydrogen across the primary membrane 14, is partially or completely reduced by the secondary device 20, thus limiting the risks of ignition. Furthermore, the secondary device 20 requires only very little electrical energy, for example less than 1% of the total electric consumption, so that it barely has an impact on the overall electric consumption of the reversible system 1.

Following a phase in EC mode and before a phase in FC mode, operation of the reversible electrochemical system 1 makes provision for an intermediate phase in which a purge is carried out in order to reduce or eliminate the amount of liquid water present in the various elements of the primary 10 and secondary 20 devices. The purge may be carried out by circulating air or nitrogen in the anode and cathode circuits of the two devices 10, 20. The nitrogen injected may have been generated by the reversible system 1, during an intermediate step, by circulating, in closed loop, air between the second cathode port 3c and the first cathode port 2c, in FC mode. Thus, the oxygen is consumed and the nitrogen is kept for the purge step.

FIG. 4B illustrates one phase of the operation of the reversible electrochemical system 1 corresponding to the FC mode, that is to say that the reversible system 1 operates as a fuel cell generating water and electrical energy from oxygen and hydrogen supplied to the second ports 3a, 3c.

Hydrogen is supplied to the second anode port 3a, and oxygen, for example contained in the air, is supplied to the second cathode port 3c. These gases may be supplied from the storage device (not represented). The hydrogen and oxygen supplied are in superstoichiometry with respect to the secondary device 20, so that the amount of hydrogen injected is greater than the amount of hydrogen oxidized at the secondary anode 23, and the amount of oxygen injected is greater than the amount of oxygen reduced at the secondary cathode 25. Furthermore, the secondary 23, 25 and primary 13, 15 electrodes are disconnected from the current sources 17, 27, and electrically connected to at least one electric charge 4, for example to the same electric charge 4.

The secondary device 20 receives hydrogen at the secondary anode 23 and oxygen at the secondary cathode 25. By the presence of a suitable anode catalyst (here platinum particles), the secondary anode 23 carries out the oxidation of hydrogen (HOR). The protons generated then diffuse across the secondary membrane 24 to the cathode 25. Furthermore, this cathode carries out the reduction of the oxygen (ORR) introduced, due to the presence of the suitable cathode catalyst (here platinum particles). Thus, the secondary device 20 produces water at the cathode 25 and produces electrical energy which then supplies the electric charge 4 when the latter is connected to the secondary device 20.

The primary device 10 then receives, originating from the secondary device 20, hydrogen at the anode 13, and also oxygen and water at the cathode 15. By the presence of a suitable anode catalyst (here platinum particles), the primary anode 13 carries out the oxidation of hydrogen (HOR). The protons generated then diffuse across the primary membrane 14 to the cathode 15. Furthermore, this cathode carries out the reduction of the oxygen (ORR) introduced, due to the presence of the suitable cathode catalyst (here platinum particles). Thus, the primary device 10 also produces water at the cathode 15, and also electrical energy that supplies the electric charge 4.

The first anode port 2a may thus receive hydrogen that has not reacted, and the second cathode port 3c receives the water generated and the air that has not reacted.

Thus, the reversible electrochemical system 1 has, also in FC mode, improved electrochemical performance due to the thin thickness of the primary membrane 14. The electric charge 4 is thus mainly supplied by the primary device 10, but may also be supplied by the secondary device 20 which then corresponds to a secondary fuel cell. The reversible electrochemical system 1 is then able to meet an increased need for electrical power due to the presence of the secondary fuel cell 20.

Following a phase in FC mode, and before the next phase in EC mode, a purge may be carried out in the reversible electrochemical system 1 in order to eliminate the liquid water while sufficiently wetting the primary 14 and secondary 24 membranes.

The process for operating the reversible electrochemical system 1 may then comprise a succession of EC phases and FC phases, advantageously separated by a purge phase that makes it possible to reduce or even eliminate the amount of liquid water present. However, the phases in EC mode make it possible to re-wet the primary membrane 14, but also the secondary membrane 24, following phases in FC mode, which makes it possible to prevent significant drying out of the membranes 14, 24. Thus the risks of premature ageing of the electrolytic membranes 14, 24 are limited. Furthermore, the overall efficiency (defined in electrolysis as gross calorific value of the gas produced over electric power consumed and vice versa in fuel cell mode) of the reversible system 1 may exhibit a gain of the order of 10% to 15% in EC mode and of the order of 15% to 25% in FC mode for a current density of 1 A/cm² approximately and a thickness of the membrane 14 ranging from 50 μm to 90 μm approximately.

Particular embodiments have just been described. Various variants and modifications will be apparent to a person skilled in the art.

1. An reversible electrochemical system, having first anode and cathode ports and opposite second anode and cathode ports, intended to operate alternately:
in electrolysis cell mode in which it is suitable for receiving water to be electrolyzed at the first anode port and for supplying oxygen to the second anode port and hydrogen to the second cathode port, and
in fuel cell mode, in which it is suitable for receiving hydrogen at the second anode port and oxygen at the second cathode port and for supplying water to the first cathode port;
the reversible electrochemical system comprising:
a primary electrochemical device comprising a membrane electrode assembly, comprising a primary anode and a primary cathode separated by a primary proton-exchange membrane,
the primary anode, connected to the first anode port and to the second anode port, being configured to carry out an oxidation of the water originating from the first anode port and an oxidation of the hydrogen originating from the second anode port, and
the primary cathode, connected to the first cathode port and to the second cathode port, being configured to carry out a reduction of protons, and a reduction of oxygen originating from the second cathode port; and
a secondary electrochemical device comprising a membrane electrode assembly, comprising a secondary anode and a secondary cathode separated by a secondary proton-exchange membrane,
the secondary anode being connected to the primary anode and to the second anode port, and being configured to carry out an oxidation of hydrogen originating from the primary anode and an oxidation of hydrogen originating from the second anode port, and
the secondary cathode being connected to the primary cathode and to the second cathode port, and being configured to carry out a reduction of protons and a reduction of oxygen originating from the second cathode port.

2. The reversible electrochemical system according to claim 1, wherein the primary electrolytic membrane has a mean thickness less than or equal to 100 μm.

3. The reversible electrochemical system according to claim 1, wherein the primary electrolytic membrane has a mean thickness less than that of the secondary electrolytic membrane.

4. The reversible electrochemical system according to claim 1, wherein the secondary electrolytic membrane has a mean thickness greater than 100 μm.

5. The reversible electrochemical system according to claim 1, comprising a primary electrical source configured to apply, in electrolysis cell mode, a first electrical signal between the primary anode and primary cathode, and a secondary electrical source configured to apply, in electrolysis cell mode, a second electrical signal between the secondary anode and secondary cathode, the second electrical signal being of the same sign as the first electrical signal and of a lower intensity.

6. The reversible electrochemical system according to claim 1, comprising at least one anode circuit for fluid circulation connecting the first anode port to the second anode port passing through the primary and secondary anodes, and at least one cathode circuit for fluid circulation connecting the first cathode port to the second cathode port passing through the primary and secondary cathodes.

7. A method for operating the reversible electrochemical system according to claim 1, comprising an alternation between:
at least one step in electrolysis cell mode of introducing water at the first anode port in superstoichiometry with respect to the primary device; and
at least one step in fuel cell mode of introducing hydrogen and oxygen respectively at the second anode and cathode ports in superstoichiometry at least with respect to the secondary device.

8. The method according to claim 7, comprising, between a step in electrolysis cell mode and a step in fuel cell mode, an intermediate step of purging liquid water present in the reversible electrochemical system by injection of nitrogen.

9. The method according to claim 8, comprising a step of obtaining nitrogen by injecting air at the second cathode port, the reversible electrochemical system operating in closed-loop fuel cell mode.
